(19) United States
(12) Patent Application Publication
(10) Pub. No.: US 2005/0279139 A1
(43) Pub. Date: Dec. 22, 2005

(54) Baffle for a glassware forming machine

(76) Inventors: Terence K. G. Howse, Toledo, OH (US); Robert E. Nuzum, Berkey, OH (US)

Correspondence Address: OWENS-ILLINOIS, INC., ONE SEAGATE, 25-LDP, TOLEDO, OH, 43666, US

(21) Appl. No.: 10/870,357

(22) Filed: Jun. 17, 2004

(51) Int. Cl. C03B 11/00

(52) U.S. Cl. 65/307; 65/171

(57) ABSTRACT

A press and blow glassware forming machine includes a blank mold having an internal cavity, a narrowing internal surface at an upper end of the cavity, and an alignment surface externally surrounding the narrowing internal surface. A baffle assembly includes a baffle cup having a rim for engaging the alignment surface on the blank mold to algin the baffle assembly with the blank mold, a baffle post moveably mounted within the baffle cup and having a narrowing external surface for engagement with the narrowing internal surface of the blank mold cavity, and a spring between the baffle cup and baffle post for biasing the baffle post into the baffle cup. The baffle assembly is moved against the blank mold bringing the baffle cup into engagement with the alignment surface of the blank mold, and then the baffle post engages the narrowing internal surface of the blank mold.

### FIELD OF THE INVENTION

The present invention relates generally to glassware forming machines, and more particularly to a baffle used to selectively close a portion of a mold cavity in a glassware forming machine.

### BACKGROUND OF THE INVENTION

Some glassware forming machines include a blank mold defining a mold cavity in which a molten gob of glass is received and initially formed into a glass parison, or preform. The glass parison is transferred from the blank mold to a blow mold wherein the glass parison is blown into its final shape. In a so-called blow-and-blow process, settle air is provided into the blank mold cavity to form the finish of the containers. The settle blow air may be provided into the blank mold cavity through a baffle that selectively closes one end of the blank mold cavity. In a so-called press-and-blow process, settle blow air is not provided into the blank mold cavity through a baffle, with the baffle merely closing one end of the blank mold cavity to facilitate forming the parisons.

### SUMMARY OF THE INVENTION

A press-and-blow glassware forming machine includes a blank mold having an internal cavity, a narrowing internal surface at an upper end of the cavity, an alignment surface externally surrounding the narrowing internal surface, and a baffle assembly. The baffle assembly includes a baffle cup having a rim for engaging the alignment surface on the blank mold to initially align the baffle assembly with the blank mold, a baffle post movably mounted within the baffle cup and having a narrowing external surface for engagement with the narrowing internal surface of the blank mold cavity, and a spring between the baffle cup and baffle post for biasing the baffle post into the baffle cup. To close the upper end of the blank mold cavity, the baffle assembly is moved against the blank mold to first bring the rim of the baffle cup into engagement with the alignment surface of the blank mold, and then to bring the baffle post into engagement with the narrowing internal surface of the blank mold.

Preferably, the baffle post includes at least two sections. A first section may be communicated with an actuator to permit and facilitate movement of the baffle assembly relative to the blank mold. A second section may be connected to the first section and preferably includes the narrowing external surface engageable with the narrowing internal surface of the blank mold cavity. Preferably, the second section is removably connected to the first section to, for example, permit a worn or damaged second section to be removed for maintenance or repair and a new one connected to the first section as desired. The second section is also preferably constructed and arranged so that when worn or damaged, it may be machined to provide fresh material at the narrowing external surface suitable to engage the narrowing internal surface of the blank mold. Desirably, this facilitates and reduces the expense of repairing the baffle assembly, and increases its useful life.

### BRIEF DESCRIPTION OF THE DRAWINGS

These and other objects, features and advantages of the present invention will be apparent from the following detailed description of the preferred embodiments and best mode, appended claims and accompanying drawings in which:

FIG. 1 is a sectional view of a baffle assembly and blank mold illustrating the baffle assembly in a first position wherein the baffle cup is engaged with the blank mold and the baffle post is retracted from the blank mold;

FIG. 2 is a cross-sectional view like FIG. 1 illustrating the baffle assembly in a second position wherein the baffle cup and baffle post are engaged with the blank mold;

FIG. 3 is a cross-sectional view of a first section of a baffle post constructed and arranged according to a second presently preferred embodiment of a baffle assembly;

FIG. 4 is a plan view of the baffle body of the baffle post of FIG. 3;

FIG. 5 is a sectional view of a baffle cup constructed and arranged according to the second presently preferred embodiment of the baffle assembly;

FIG. 6 is a plan view of the baffle cup of FIG. 5;

FIG. 7 is an elevational view of a baffle post element of the baffle post constructed and arranged according to the second presently preferred embodiment of the baffle assembly;

FIG. 8 is a plan view of the baffle post element of the baffle post shown in FIG. 7; and

FIG. 9 is a cross-sectional view of the second embodiment of the baffle assembly with its components shown as assembled for use.

### DETAILED DESCRIPTION OF THE PREFERRED EMBODIMENTS

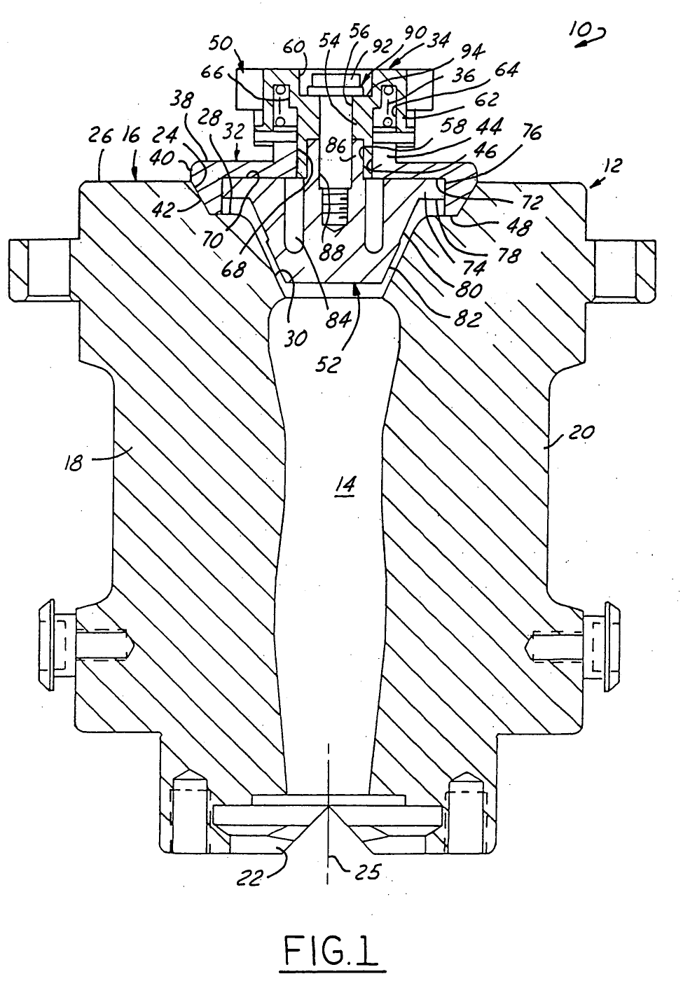

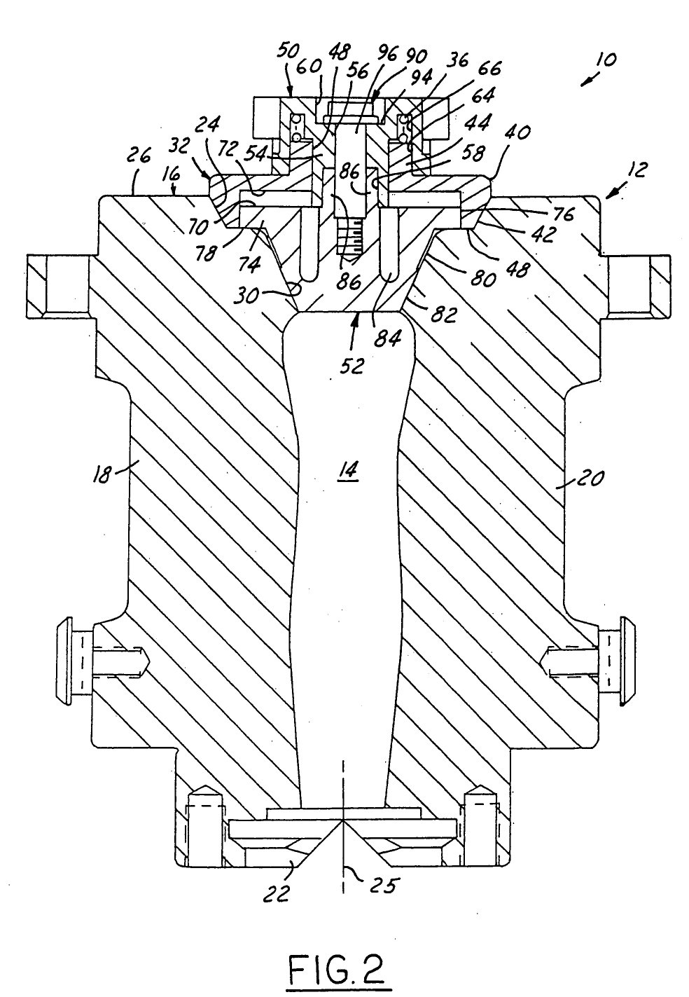

Referring in more detail to the drawings, FIGS. 1 and 2 illustrate a first presently preferred embodiment of a baffle assembly 10 for a glassware forming machine. The baffle assembly 10 is preferably employed with a blank mold 12 including a cavity 14 having a contour to form a molten glass gob into a glass parison of desired form. The blank mold 12 is open at one end 16 to the cavity 14 to receive a molten glass gob into the cavity 14. The baffle assembly 10 engages and closes the open end of the blank mold 12 to facilitate forming a glass gob into a glass parison in the mold cavity 14.

The blank mold 12 preferably includes two mold halves 18, 20 that when mated together define the mold cavity 14 between them. At a lower end of the mold cavity 14, one or more recesses 22 in the mold halves may be provided to receive at least a portion of a neck ring assembly (not shown). The neck ring assembly receives a portion of the glass gob therein to form a finish area of a glass parison about which the glass parison may be handled by the neck ring assembly for transfer to a blow mold. At the other end of the mold cavity 14, an alignment surface 24 is provided to facilitate aligning the baffle assembly 10 with the blank mold 12. The alignment surface 24 is preferably circumferentially continuous and is tapered so that it narrows from an upper end 16 of the blank mold 12 toward the mold cavity 14. In relation to a vertical axis 25 of the blank mold cavity 14, the alignment surface 24 extends axially from an upper surface 26 of the blank mold 12 and is radially tapered. The alignment surface 24 preferably terminates at a stop surface or shoulder 28 that may extend generally radially inwardly from the alignment surface 24. The blank mold 12 preferably further includes a narrowing internal surface 30 extending axially from the stop surface 28 and leading to the blank mold cavity 14. The narrowing internal surface 30 is preferably circumferentially continuous, extends axially a desired distance and is radially tapered such that it narrows along its axial extent leading toward the blank mold cavity 14.

The baffle assembly 10 includes a baffle cup 32, a baffle post 34 and a spring 36 disposed between the baffle cup 32 and baffle post 34. The baffle cup 32 preferably includes a radially outwardly extending wall 38 and a peripheral axially extending rim 40 depending from the wall 38. The rim 40 is preferably circumferentially continuous and includes a radially tapered outer surface 42 for engaging the alignment surface 24 of the blank mold 12. The baffle cup 32 preferably also includes an axially extending and annular wall 44 that defines at least in part a bore 46 through the baffle cup 32. At its lower end, the baffle cup 32 preferably includes a generally planar annular face 48 adapted to engage the shoulder 28 of the blank mold 12 when the baffle cup 32 is fully seated on the blank mold 12.

The baffle post 34 preferably includes a baffle body 50 and a baffle post element 52 connected to the baffle body 50. The baffle body 50 of the baffle post 34 preferably includes a generally cylindrical central portion 54 with a through bore 56 and first and second counter bores 58, 60 formed therein. The second counter bore 60 is preferably disposed axially spaced from and facing in the opposite direction of the first counter bore 58. Extending radially outwardly from the central portion 54 is a circumferentially continuous and generally annular flange 62 including a preferably circumferentially continuous groove 64 in which the upstanding wall 44 of the baffle cup 32 is slidably received to permit movement of the baffle post 34 relative to the baffle cup 32. The groove 64 may include a spring retaining portion 66 in which the spring 36 is received between the baffle body 50 of the baffle post 34 and the baffle cup 32. The spring retaining portion 66 may have a reduced radial dimension or extent to more closely receive and position the spring 36 therein. Of course, other constructions and arrangement may be used, for example, without limitation, a plurality of pockets could be provided in the first section with a separate spring received in each of the plurality of pockets so that each spring is trapped between the baffle post and baffle cup. The spring 36 is preferably captured in compression between the baffle post 34 and baffle cup 32. In the presently preferred embodiment, the cylindrical central portion 54 of the baffle body 50 is slidably received within the annular wall 44 of the baffle cup 32 and may guide the movement of the baffle post 34 relative to the baffle cup 32. In this manner, an inner surface 68 of the annular wall 44 of the baffle cup 32 may provide a bearing surface for the movement of the baffle post 34 relative to the baffle cup 32.

The baffle post element 52 of the baffle post 34 preferably includes a generally planar and annular upper surface 70 adapted to be received in the baffle cup 32 adjacent to a lower surface 72 of its wall 38 and generally within the depending rim 40. The baffle post element 52 preferably includes a radially outwardly extending flange 74 providing an axially extending bearing surface 76 slidably engaged with and guided by the inner surface of the depending rim 40 of the baffle cup 32. A lower surface 78 of the flange 74 may engage the shoulder 28 on the blank mold 12 when the baffle post 34 is fully advanced relative to the blank mold 12 as shown in FIG. 2. The baffle post element 52 preferably also includes a narrowing external surface 80 adapted to engage and seal with the narrowing internal surface 30 of the blank mold 12. The external surface 80 is preferably circumferentially continuous, extends axially and is radially tapered desirably at a complementary angle to the taper of the narrowing internal surface 30 of the blank mold 12 providing a circumferentially continuous seal between the baffle post element 52 and the blank mold 12 when the baffle post 34 is fully advanced into the blank mold 12.

The external surface 80 may include a radially outwardly extending section 82 that is preferably circumferentially continuous and adapted to engage the narrowing internal surface 30 of the blank mold 12. Should this radially outwardly extending section 82 of the external surface 80 become damaged or worn in use, it can be machined in part or in whole to provide a fresh layer or surface of material still having the complementary angle to that of the internal surface 30 of the blank mold 12 to enable continued service of the baffle post 34 with limited maintenance or repair. Since machining the external surface 80 will reduce its diameter, the baffle post element 52 will have to be axially adjusted to ensure it engages to the correct depth into the blank mold 12. This can be done by providing a shim that initially advances the baffle post element 52 a certain distance to maintain the same length in use before the machining or maintenance of the baffle post element 52. An annular groove 84 or passages may be formed in the baffle post element 52 to provide a void, the purpose of which is to increase its operating temperature. The baffle post element 52 is preferably through hardened or hardened to a desired depth from its surface 80 such that after machining a hardened external surface 80 is presented for engagement with the internal surface 30 of the blank mold 12.

In one presently preferred embodiment, the baffle post element 52 of the baffle post 34 includes an upstanding annular wall 86 that is constructed and arranged to be disposed at least partially within the first counter bore 58 of the baffle body 50. The upstanding wall 86 preferably includes internal threads 88 to receive a coupler such as a fastener 90 disposed through the bore 56 in the baffle body 50 and threadably received in the baffle post element 52. The fastener preferably has an enlarged head 92 seated on a shoulder 94 provided by the second counter bore 60 of the baffle body 50 and a threaded shank 96 received in the baffle post element 52. In this manner, the baffle post element 52 is removably connected to the baffle body 50 so that the baffle post element 52 can be removed for repair or maintenance as needed and a new baffle post element 52 can be attached to the baffle body 50 to reduce the down time and increase the efficiency of the glassware forming machine.

In use, the baffle assembly 10 is advanced toward and into engagement with the blank mold 12. The spring 36 yieldably biases the baffle cup 32 into engagement with the baffle post element 52, and more specifically, the lower surface 72 of the baffle cup 32 engages the upper surface 70 of the baffle post element 52. As best shown in FIG. 1, the rim 40 of the baffle cup 32 initially engages the alignment surface 24 of the blank mold 12 to align the baffle assembly 10 with the blank mold cavity 14. With the baffle cup 32 fully seated on the blank mold 12, the baffle post 34 can be advanced toward the blank mold cavity 14 until the narrowing external surface 80 of the baffle post element 52 engages the narrowing internal surface 30 of the blank mold 12 thereby closing the upper end of the blank mold cavity 14. Once closed, a molten glass gob can be formed, such as by pressing into a desired shape of a glass parison that may be subsequently processed into an article of glassware, such as a glass container. In advancing the baffle post 34 relative to the baffle cup 32, the spring 36 becomes increasingly compressed and provides a force that yieldably biases the baffle post element 52 toward the wall 38 of the baffle cup.

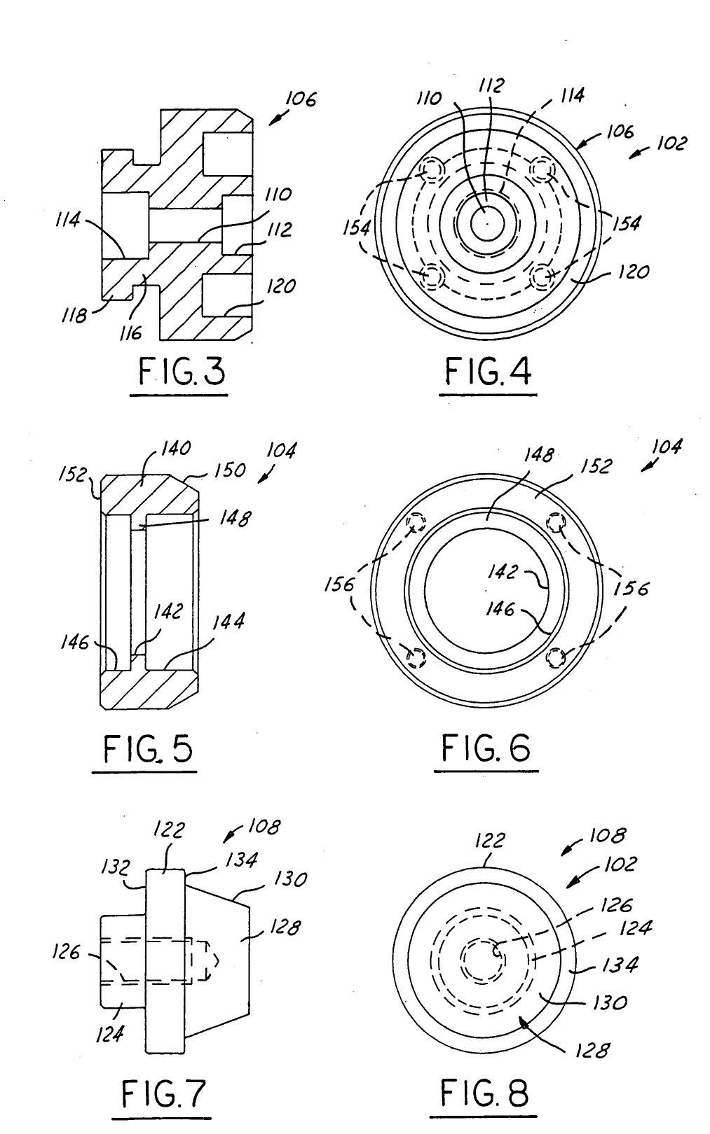

A second presently preferred embodiment of a baffle assembly 100 is shown in FIGS. 3-9. The baffle assembly 100 includes a baffle post 102 and a baffle cup 104. The baffle post 102 is preferably formed in two sections, like the previous embodiment, with a baffle body 106 and a baffle post element 108 that is preferably removably connected to the baffle body 106.

As shown in FIGS. 3 and 4, the baffle body 106 of the baffle post 102 has a central bore 110 and opposed first and second counter bores 112, 114 at opposite ends of the bore 110. The baffle body 106 also includes an upstanding wall 116 with a radially outwardly extending rim 118 that may receive a clamp or other connector to facilitate driving the baffle post 102 relative to the blank mold 12. An annular and preferably circumferentially continuous groove 120 is formed radially outwardly spaced from the central bore 110.

As shown in FIGS. 7 and 8, the baffle post element 108 of the baffle post 102 has a circumferentially continuous and radially outwardly extending flange 122 disposed between an upstanding annular wall 124 that defines in part a blind bore 126 in the baffle post element 108 and a portion 128 having narrowing external surface 130 for engagement with the narrowing internal surface 30 of a blank mold 12. The narrowing external surface 130 is preferably circumferentially continuous and may be machined for maintenance or repair generally as set forth with respect to the previous embodiment. The radially outwardly extending flange 122 provides a shoulder or a surface 132 engageable with the baffle cup 104 and a generally opposed shoulder or annular face 134 that may engage the blank mold 12 when the baffle post 102 is in its fully extended position with respect to the blank mold 12.

As shown in FIGS. 5 and 6, the baffle cup 104 may include a generally annular body 140 having a through bore 142 and preferably a pair of generally opposed counter bores 144, 146 at opposite ends of the through bore 142 defining a radially inwardly extending flange 148. To facilitate aligning the baffle assembly 100 with a blank mold 12, the baffle cup 104 preferably includes a tapered or narrowing rim 150 or external surface adapted to engage the alignment surface 24 of the blank mold 12. One end 152 of the baffle cup 104 is adapted to be received in the annular groove 120 in the baffle body 106 of the baffle post 102, with a spring 153 trapped in compression between them to yieldably bias the baffle post 102 relative to the baffle cup 104. One or more pockets 154 may be formed in the area of the annular groove 120 of the baffle body 106 of the baffle post 102 and in the baffle cup 104 with the pockets in the baffle body 106 aligned with pockets 156 in the baffle cup 104 so that each pair of aligned pockets receives a separate spring yieldably biasing the baffle post. Of course, other constructions and arrangements to yieldably bias the baffle post relative to the baffle cup may be employed.

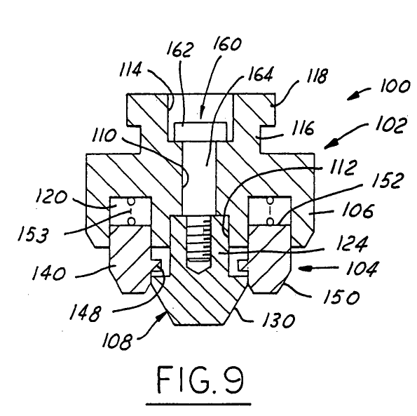

In assembly, as shown in FIG. 9, the baffle cup 104 is disposed in the baffle body 106 of the baffle post 102 so that the end 152 of the baffle cup 104 is received in the annular groove 120 in the baffle body 106. The baffle post element 108 is positioned in the baffle cup 104 so that the axially extending annular wall 124 is received through the bore 142 in the baffle cup 104 and preferably into the first counter bore 112 in the baffle body 106. The flange 122 of the baffle post element 108 preferably engages the radially inwardly extending flange 148 of the baffle cup 104. To connect the baffle body 106 and the baffle post element 108, a coupler such as a fastener 160 may be employed, like the previous embodiment. The fastener 160 preferably has an enlarged head 162 received in the second counter bore 114 of the baffle body 106 and seated on the main body of the baffle body 106, and a threaded shank 164 passing through the bore 110 of the baffle body 106 and being threadedly received in the blind bore 126 in the baffle post element 108. The spring or springs disposed between the baffle post 102 and baffle cup 104 yieldably bias the baffle post 102 tending to move the baffle post element 108 into the counter bore 146 of the baffle cup 104 as generally set forth with respect to the previous embodiment.

Those of ordinary skill in the art will recognize that the preceding disclosure has been provided in terms of description rather than limitation. Certain relative terms like above, below, upper, lower, vertical and the like are used to describe the apparatus in the orientation(s) shown in the drawings and do not limit the possible orientations of the apparatus generally or any part thereof. While presently preferred embodiments or forms of the invention have been disclosed herein, modifications and substitutions can be made without departing from the spirit and scope of the invention as set forth in the appended claims. For example, without limitation, while threaded fasteners have been disclosed as connecting together the baffle body and baffle post element of the baffle post, mating portions of the baffle body and baffle post element may have complementary threads so that they are connected together without any additional fasteners. Alternatively, the baffle body and baffle post element can be connected together by substantially any suitable means including various friction fit arrangements, clamps, among others. Still other modifications and substitutions will be apparent to those skilled in the art in view of this disclosure and the appended claims.

1. A press-and-blow glassware forming machine that includes:
a blank mold having an internal cavity with an upper end having a narrowing internal surface and an alignment surface externally surrounding said narrowing internal surface, and
a baffle assembly that includes a baffle cup having a rim for engaging said alignment surface on said mold to align said baffle assembly with said mold,
a baffle post movably mounted within said baffle cup and having a narrowing external surface for engagement with said narrowing internal surface of said mold cavity, and
a spring between said baffle cup and said baffle post for biasing said baffle post into said cup, such that movement of said baffle assembly against said mold first brings said rim of said baffle cup into engagement with said alignment surface of said mold, and then brings said baffle post into engagement with said narrowing internal surface of said mold to close said upper end of said mold cavity.

2. The glassware forming machine of claim 1 wherein the spring is captured in compression between the baffle cup and baffle post.

3. The glassware forming machine of claim 1 wherein the baffle post includes a groove and the baffle cup includes a flange slidably received at least partially in the groove and said spring is captured in the groove between the baffle post and the flange of the baffle cup.

4. The glassware forming machine of claim 1 wherein the baffle post includes a baffle body and a baffle post element connected to the baffle body with said narrowing external surface being formed on the baffle post element.

5. The glassware forming machine of claim 4 wherein the baffle post element is removably connected to the baffle body.

6. The glassware forming machine of claim 5 which also includes a coupler connecting together the baffle body and baffle post element.

7. The glassware forming machine of claim 6 wherein said baffle body includes a bore and said baffle post element includes a threaded bore that is aligned with the bore of the baffle body in assembly, and said coupler includes a fastener having a threaded shank received through the bore in the baffle body and in the threaded bore of the baffle post element to removably connect the baffle body and baffle post element.

8. The glassware forming machine of claim 1 wherein said narrowing external surface includes a section that extends outwardly from the adjacent portion of the narrowing external surface, and is adapted to engage the narrowing internal surface of the blank mold.

9. The glassware forming machine of claim 8 wherein said section is disposed at substantially the same angle as the adjacent portion of the narrowing external surface.

10. The glassware forming machine of claim 1 wherein said baffle cup includes a bore and said baffle post extends through said bore.

11. The glassware forming machine of claim 4 wherein at least a portion of said baffle body and at least a portion of said baffle post element are slidably received through said bore in the baffle cup.

12. The glassware forming machine of claim 4 wherein at least a portion of the baffle post element of the baffle post is slidably received through said bore in the baffle cup.

13. The glassware forming machine of claim 1 wherein said baffle cup includes a recess in which at least a portion of the baffle post is received, and said baffle post includes an annular guide surface adapted to be closely slidably received within the recess to guide movement of the baffle post relative to the baffle cup.

14. The glassware forming machine of claim 13 wherein said annular guide surface extends radially outwardly from said narrowing external surface.

15. In a press-and-blow glassware forming machine having a pair of blank mold sections that form a blank mold cavity having an upper end with a narrowing internal surface and a baffle for closing the upper end of the blank mold cavity, the improvement in which:
said blank mold has an external narrowing alignment surface surrounding the upper end of the blank mold cavity, and
said baffle includes a baffle cup with a rim for engaging said alignment surface,
a baffle post movably mounted with said baffle cup and having a narrowing external surface for engagement with said narrowing internal surface to close said upper end of said mold cavity, and
a spring captured in compression between said baffle cup and said baffle post to bias said baffle post into said cup.

16. The glassware forming machine of claim 15 wherein the baffle post includes a groove and the baffle cup includes a flange slidably received at least partially in the groove and said spring is captured in the groove between the baffle post and the flange of the baffle cup.

17. The glassware forming machine of claim 15 wherein the baffle post includes a baffle body and a baffle post element connected to the baffle body with said narrowing external surface being formed on the baffle post element.

18. The glassware forming machine of claim 17 wherein the baffle post element is removably connected to the baffle body.

19. The glassware forming machine of claim 18 which also includes a coupler connecting together the baffle body and baffle post element.

20. The glassware forming machine of claim 19 wherein said baffle body includes a bore and said baffle post element includes a threaded bore that is aligned with the bore of the baffle body in assembly, and said coupler includes a fastener having a threaded shank received through the bore in the baffle body and in the threaded bore of the baffle post element to removably connect the baffle body and baffle post element.

21. The glassware forming machine of claim 15 wherein said narrowing external surface includes a section that extends outwardly from the adjacent portion of the narrowing external surface, and is adapted to engage the narrowing internal surface of the blank mold.

22. The glassware forming machine of claim 21 wherein said section is disposed at substantially the same angle as the adjacent portion of the narrowing external surface.

23. The glassware forming machine of claim 15 wherein said baffle cup includes a bore and said baffle post extends through said bore.

24. The glassware forming machine of claim 17 wherein at least a portion of said baffle body and at least a portion of said baffle post element are slidably received through said bore in the baffle cup.

25. The glassware forming machine of claim 17 wherein at least a portion of the baffle post element of the baffle post is slidably received through said bore in the baffle cup.

26. The glassware forming machine of claim 1 wherein said baffle cup includes a recess in which at least a portion of the baffle post is received, and said baffle post includes an annular guide surface adapted to be closely slidably received within the recess to guide movement of the baffle post relative to the baffle cup.

27. The glassware forming machine of claim 26 wherein said annular guide surface extends radially outwardly from said narrowing external surface.
